(19) United States
(12) Patent Application Publication
(10) Pub. No.: US 2009/0087305 A1
(43) Pub. Date: Apr. 2, 2009

(54) Exit stay apparatus with intermediate flange

(76) Inventor: Alexander Gokhman, San Francisco, CA (US)

Correspondence Address: Alexander Gokhman, 3031 NORIEGA STREET, SAN FRANCISCO, CA, 94122, US

(21) Appl. No.: 11/904,579

(22) Filed: Sep. 28, 2007

(51) Int. Cl. F03B 11/04

(52) U.S. Cl. 415/161; 415/211.2

(57) ABSTRACT

The invention is an Exit Stay Apparatus with Intermediate Flange for Francis and propeller hydraulic turbines. The purpose of the invention is to improve the effectiveness of known Exit Stay Apparatus (U.S. Pat. No. 6,918,744, July 2005, for Hydraulic Turbine and Exit Stay Apparatus therefor) in eliminating the axial central vortex and, therefore, in increasing the efficiency and decreasing the flow pressure pulsations in draft tube cone at off optimum operating regimes. The new Exit Stay Apparatus has an intermediate flange between exit stay crown and periphery and two sets of exit stay vanes: crown exit stay vanes secured to the exit stay crown and the intermediate flange and peripheral exit stay vanes secured to the intermediate flange and following to the periphery. When installed in the turbine the peripheral exit stay vanes are secured at the periphery. There are more crown exit stay vanes than the peripheral exit stay vanes and their profiles are longer than the profiles of the peripheral exit stay vanes. The Exit Stay Apparatus with Intermediate Flange is expected to have the same peak efficiency as known Exit Stay Apparatus.

### BACKGROUND OF THE INVENTION

This invention relates to reaction hydraulic turbines. More specifically, the invention relates to reaction hydraulic turbines with a radial intake having a spiral casing with inlet stay vanes, a radial guide gate apparatus with wicket gates, either a mixed flow runner or an axial flow runner with runner blades secured to the runner crown, exit stay apparatus and a draft tube with a cone and an elbow.

At any hydroelectric plant the water level in the upper reservoir varies in time. The upper reservoir level depends on the flow of the river on which the plant is situated and on the seasonal demand of the power grid supplied by the plant. Turbine head, denoted by Hₜ, varies along with the upper reservoir level.

Power output of a turbine, denoted by Pₜ, is continually adjusted to meet the immediate demand of the power grid. Thus, Pₜ is also a time dependent variable. Power output of a reaction hydraulic turbine is adjusted by changing the discharge angle of the wicket gates of the guide gate apparatus.

Power output of a turbine Pₜ (kW) is given by the following formula:

Pₜ=gηₜQₜHₜ (1)

where:

ηₜ is the efficiency of the turbine,

Hₜ is the turbine head (m),

Qₜ is the flow rate through the turbine (m³/sec), and

g is gravitational acceleration (g=9.81 m/sec²).

Formula (1) shows that, for a fixed value of Hₜ, power output Pₜ is proportional to the flow rate Qₜ. The flow rate of the turbine can be adjusted by varying the wicket gate discharge angle α₁. The wicket gate discharge angle is the angle of a wicket gate exit element relative to the circumference of the turbine. The flow rate of the turbine is an increasing function of the wicket gate discharge angle.

The following considerations involve the concept of an elementary turbine. The flow inside the turbine passages is partitioned into thin laminae by axisymmetric stream surfaces of averaged meridional flow. An elementary turbine is the part of a turbine located in one such thin lamina.

For an elementary turbine the difference between the values of whirl at the wicket gate exit and at the runner blade exit, denoted by Δ(VᵤR0, is given by Euler's equation:

$$Δ ( {V}_{u} R ) = \frac{g {η}_{t} {H}_{t}}{ω} \qquad ( 2 )$$

where ω is the angular velocity of the turbine (ω=πN/30, where N is the rotation rate of the turbine in rpm). Meanwhile, for the i-th elementary turbine, the value of whirl at the wicket gate exit, denoted by [(VᵤR)₁]ᵢ, is given by

[(VᵤR)₁]ᵢ=[(VₘR)₁]ᵢ cot α₁ (3)

where [(VₘR)₁]ᵢ is the moment of velocity meridional component with respect the turbine axis at the wicket gate exit edge. Combining (2) and (3) one obtains the formula for whirl at the runner blade trailing edge for the i-th elementary turbine, denoted by [(VᵤR)₂]ᵢ:

$${[ {( {V}_{u} R )}_{2} ]}_{i} = {[ {( {V}_{m} R )}_{1} ]}_{i} cot {α}_{1} - \frac{g {η}_{t} {H}_{t}}{ω} \qquad ( 4 )$$

Formula (4) shows that for each elementary turbine the value of whirl at the runner blade exit varies with the values of Pₜ (via α₁) and Hₜ. In particular, whirl does not necessarily vanish at the runner crown. If (VᵤR)₂≠0 at the runner crown, an axial circular vortex forms at the runner crown tip. Otherwise Vᵤ=(VᵤR)₂/R would tend to infinity as R→0 leading to a contradiction (see L. M. Milne-Thomson, Theoretical Hydrodynamics, Macmillan [1960]).

The axial circular vortex core (0≦R≦R_{cu}, where R_{cu} is the core radius) rotates as a solid body with velocity:

$${V}_{u} = \frac{{ω}_{cv} R}{2} \qquad ( 5 )$$

where ω_{cv} is distributed vorticity inside the core. The flow outside the axial circular vortex (R>R_{cv}) is similar to the flow after the runner blade trailing edge and has the same-values of [(VᵤR)₂]ᵢ for the i-th elementary turbine. The axial circular vortex produces strong pulsations in draft tube. It ultimately dissipates due to the viscosity of water, causing a significant loss of head in turbine what results in a decrease of turbine efficiency given by:

$${Δη}_{cv} = \frac{{( {V}_{u} R )}_{2 cr}^{2}}{2 {gR}_{dt}^{2} {H}_{t}} \qquad ( 6 )$$

where (VᵤR)_{2cr} is whirl at the runner blade trailing edge in the elementary turbine adjacent to the runner crown and R_{dt} is the draft tube cone inlet radius (see G. I. Topazh, Computation of Integral Hydraulic Indicators of Hydromachines, Leningrad [1989]).

In order to avoid strong pulsation in draft tube and a loss of efficiency due to the axial circular vortex in the design regime, turbines are designed to have (VᵤR)_{2cr}=0 for the design values of power output (Pₜ)_{d} and head (Hₜ)_{d}. However, with variation of Hₜ and especially with variation of Pₜ, there is a significant loss of efficiency due to the axial circular vortex in reaction hydraulic turbines with runner blades secured to the runner crown and having a draft tube with an elbow.

In in 2002 I, Alexander Gokhman, invented exit stay apparatus (U.S. Pat. No. 6,918,744, July 2005, for Hydraulic Turbine and Exit Stay Apparatus therefor), which was supposed to eliminate the central vortex in the reaction turbine with fixed runner blades at all operating regimes off optimum and, therefore, to improve the efficiency and decrease an amplitude of the pressure pulsation in a draft tube cone.

This exit stay apparatus has an exit stay crown and exit stay vanes secured to the exit stay crown. When installed in the turbine, the exit stay crown is located immediately after the runner crown, which is truncated at the bottom by a plane perpendicular to the central axis of the turbine. The exit stay crown has the shape of a cup and together with the truncated runner crown forms water passages after the runner blade crown profile exit. The exit stay vanes are
(a) arranged in a circular array around the turbine axis,
(b) located after the runner blades, and
(c) secured at the periphery either to the draft tube cone or to an exit stay flange secured to the turbine discharge ring and to the draft tube cone.

The said exit vanes are redirecting the flow leaving the runner crown in order to eliminate (VᵤR)_{2cr} and, therefore the central vortex. They are also keeping this exit stay apparatus in the proper position. In addition to it the profiles of the peripheral parts of exit vanes in order not to decrease the maximum efficiency of the turbine must have as little as possible solidity of profile cascades, L/T, where L is the length of said exit vane profile and T is the maximum distance between adjacent profiles along circumference. So the lengths of the peripheral profiles, and the number of the vanes must be kept to the minimum permitted by stresses in exit vanes.

The exit stay apparatus according to the U.S. Pat. No. 6,918,744 was tested in General Electric high head Francis turbine at Laval University, Quebec City, Canada, in July-September of 2007.

The exit stay apparatus had eight exit vanes with the solidity of the cascade formed by peripheral exit vane profiles, (L/T)ₚₑᵣ=0.10, and the solidity of the cascade formed by crown profiles, (L/T)_{cr}=1.10. The test demonstrated that the turbine with exit stay apparatus
(a) had the same peak efficiency, ηₘₐₓ as the turbine without exit stay apparatus,
(b) at the operating regime with head equal to 0.72 of optimal head had the maximum efficiency for this head 2% higher than the turbine without exit stay apparatus at the optimal power for this head, (Pₕ)ₒₚₜ.

The test also demonstrated that exit stay apparatus
(a) was capable to eliminate the central vortex only for the heads smaller than optimal head and only for the powers in the range: 0.83(Pₕ)ₒₚₜ−1.07(Pₕ)ₒₚₜ,
(b) improved the efficiency of the turbine and decreased the pressure pulsations in its draft tube only at operating regimes with eliminated central vortex.

In order to enable exit stay apparatus to eliminate central vortex at all operating regimes and, therefore, increase efficiency of reaction turbine and decrease pressure pulsations in its draft tube cone at these regimes, one must increase the value of (L/T)_{cr} with increasing the value of (L/T)ₚₑᵣ (the increase of (L/T)ₚₑᵣ will lead to decrease of peak efficiency, ηₘₐₓ) However, in order do it one must take into account that it is impossible to substantially increase the value of (L/T)_{cr} by increasing L_{cr} due to limited length of the exit stay crown side. So there is only one way to do that by decreasing T_{cr} by means of increasing the number of exit vanes, Nₑᵥ. However, the increase of Nₑᵥ will lead to decrease of ηₘₐₓ, since Lₚₑᵣ can not be decreased because of structural considerations.

It is clear from discussion above that the exit stay apparatus according to the U.S. Pat. No. 6,918,744, July 2005 cannot increase the efficiency of reaction turbine and decrease the pressure pulsations in its draft tube cone at all necessary operating regimes without decreasing ηₘₐₓ.

### BRIEF SUMMARY OF THE INVENTION

The present invention discloses an exit stay apparatus with intermediate exit flange for a reaction hydraulic turbine with runner blades secured to the runner crown. The purpose of the invention is to eliminate the loss of turbine efficiency and strong pulsations in draft tube caused by the axial circular vortex in all turbine operating regimes other than optimum without a decrease in maximum efficiency. The proposed exit stay apparatus can be incorporated not only into newly fabricated reaction hydraulic turbines, but also retrofitted into existing Francis and propeller turbines.

This exit stay apparatus has an exit stay crown and an intermediate exit flange. It also has two sets of exit stay vanes, the crown exit stay vanes and the peripheral exit stay vanes. The crown exit stay vanes are secured to the exit stay crown and to the intermediate exit flange. The peripheral exit stay vanes are secured to the intermediate exit flange. When installed in the turbine, the exit stay crown is located immediately after the runner crown, which is truncated at the bottom by a plane perpendicular to the central axis of the turbine. The exit stay crown has the shape of a cup and together with the truncated runner crown forms the water passages after the runner blade crown profile exit. The intermediate exit flange is formed by two surfaces of revolution. Its meridional cross-section has a shape of non-symmetric profile with rounded inlet and sharp exit. The intermediate exit flange peripheral side, the side facing the periphery, is formed, excluding the inlet part, by a stream surface of the flow leaving the runner of turbine when it is without the exit stay apparatus. Its crown side, the side facing the exit stay crown, is formed by a surface of revolution which due to the thickness of its meridional cross-section does not have the shape of stream surface of the flow leaving the runner of turbine when it is without the exit stay apparatus.

The crown and peripheral exit stay vanes are arranged in a circular arrays around the turbine axis and located after the runner blades. The peripheral exit stay vanes secured at the periphery either to the draft tube cone or to an exit stay flange secured to the turbine discharge ring and to the draft tube cone.

Inlet edges of the crown and peripheral exit vanes are located near the runner blades exit edges. However, for each stream surface of the flow leaving the runner the distance between the runner blade exit edge and the exit stay vane inlet edge is preferably not smaller than the distance between two adjacent runner blade exit edges along the circumference, denoted by T. This is in order to avoid strong pulsations at the exit stay vane inlet edges.

The solidity of the cascades formed by profiles of the crown and peripheral exit vanes is (L/T)ₑᵥ, where L is the length of the cascade profile. The solidity of the peripheral exit vane cascades, [(L/T)ₑᵥ]ₚₑᵣ, varies from values close to 1.0 at the intermediate exit flange to relatively small values smaller than 0.2 at the periphery. The solidity of the crown exit vane cascades, [(L/T)ₑᵥ]_{cr}, could be as high as 2.0 and even higher if it is necessary for eliminating the central vortex at all operating regimes. The length and maximum thickness for the peripheral exit vane profiles along its span are determined from structural considerations. The maximum length of the crown exit vane profile must be less than the length of the exit stay crown side.

The profiles of the crown and peripheral exit stay vanes are subsets of the axisymmetric stream surfaces of the flow leaving the turbine runner. The profile contours are the lines of intersection of said axisymmetric stream surfaces with exit vanes bounding surfaces.

Let (βᵢ)_{des} and (βₑ)_{des} denote respectively the design angles of inlet and exit profile elements relative to the turbine circumference. Along its leading edge each profile the inlet angle (βᵢ)_{des} is given by:

$${( tan {β}_{i} )}_{des} = \frac{{[ {( {V}_{m} )}_{i} ]}_{opt}}{{[ {( {V}_{u} )}_{i} ]}_{opt}} \qquad ( 7 )$$

where [(Vₘ)ᵢ]ₒₚₜ and [(Vᵤ)ᵢ]ₒₚₜ are meridional and circumferential components of velocity along the leading edge at the optimum operating regime of the turbine. The exit stay vane exit angle along its trailing edge is (βₑ)_{des}=90°.

The geometry of the proposed exit stay apparatus, described above, enables it to increase the, turbine efficiency and substantially decrease the amplitude of pressure pulsations in draft tube cone at operational regimes other than optimum more effectively than old art exit stay apparatus with the same peak efficiency

### BRIEF DESCRIPTION OF THE SEVERAL VIEWS OF THE DRAWINGS

FIG. 1 is an elevation view, partially in cross-section, of a radial intake turbine with a mixed flow runner having a periphery rim and with an exit stay apparatus with intermediate exit flange having an exit stay flange;

FIG. 2 is an elevation view, partially in cross-section, of an exit stay apparatus with intermediate exit flange having an exit stay flange.

### DETAILED DESCRIPTION OF THE INVENTION

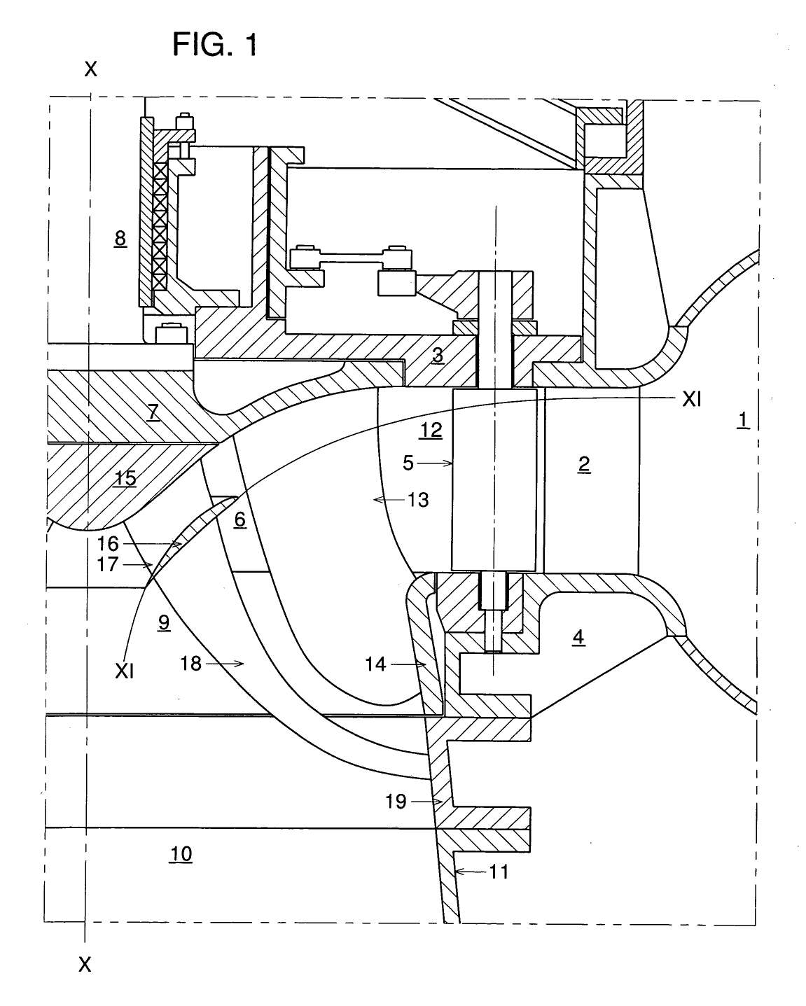

Referring now to FIG. 1, a radial intake turbine with mixed flow runner a periphery rim and with an exit stay apparatus with intermediate exit flange having an exit stay flange is shown. The installation comprises a spiral casing 1 with radial stay vanes 2, upper head cover 3 and a discharge ring 4 both secured to the spiral casing 1, a guide gate apparatus 12 with radial wicket gates 5 pivotally secured to the head cover 3 and the discharge ring 4, a mixed flow runner 6 with a runner crown 7 secured to the turbine shaft 8, exit stay apparatus 9, and a draft tube 10 with draft tube cone 11, and a draft tube elbow and horizontal diffuser not shown in FIG. 1. Mixed-flow runner 6 together with shaft 8 rotates around the central axis X-X.

The power output of the turbine is regulated by radial wicket gates 5 which can be pivoted from a maximum open position to a closed position. The mixed flow runner 6 comprises a runner crown 7, turbine blades 13, and rim 14. Turbine blades 13 are secured to the runner crown 7 and to the rim 14. Rim 14 forms turbine water passages at the periphery. The runner crown 7 is truncated by a plane perpendicular to central axis X-X.

Exit stay apparatus 9 comprises exit stay crown 15, intermediate exit flange 16 crown exit stay vanes 17, peripheral exit stay vanes 18, and exit stay flange 19. Plurality of crown exit stay vanes 17 and peripheral exit stay vanes 18 are arranged in a circular array around the central axis X-X.

Inlet edges of the crown exit vanes 17 and peripheral exit vanes 18 are located near the runner blades 13 exit edges. However, for each stream surface of the flow leaving the runner 6 the distance between the runner blade 13 exit edge and the inlet edges of the crown exit stay vanes 17 and the peripheral exit stay vanes 18 is preferably not smaller than the distance between two adjacent runner blade 13 exit edges along the circumference, T. This is in order to avoid strong pulsations at inlet edges Of the exit stay vanes 17 and 18.

The crown exit stay vanes 17 are secured to the exit stay crown 15 and to the crown side of the intermediate exit flange 16. The peripheral exit stay vanes 18 are secured to the peripheral side of the intermediate exit flange 16 and the exit stay flange 19. The exit stay crown 15 is installed immediately under the truncated runner crown 7 and together with runner crown 7 forms the water passages, which in turbines without exit stay apparatus are formed solely by the runner crown 7. The exit stay flange 19 is secured to the discharge ring 4 and to the draft tube cone 11. FIG. 1 also shows a stream surface of meridional flow XI-XI leaving the runner 6 at optimum operating regime in the turbine when exit stay apparatus is not installed and separating the small part the flow around the runner crown 7 from the rest of the flow leaving the runner. It is easy to see from FIG. 1, that the peripheral side of the intermediate exit flange 16 excluding its inlet is formed by the stream surface of meridional flow XI-XI.

The solidity of cascades of the peripheral exit vanes 18, [(L/T)ₑᵥ]ₚₑᵣ varies from values close to 1.0 at the intermediate exit flange 16 to small values close to 0.1 at the periphery. The number of the peripheral exit vanes 18, (Nₑᵥ)ₚₑᵣ, and the maximum thicknesses and lengths of their profiles along the span are determined from structural considerations.

The solidity of cascades of the crown exit vanes 17, [(L/T)ₑᵥ]ₚₑᵣ, could be as high as 2.0 and even higher if it is necessary for eliminating the central vortex at all operating regimes. The number of the crown exit vanes 17, (Nₑᵥ)_{cr} is determined by [(L/T)ₑᵥ]_{cr} and the length of the outer boundary in the meridional cross-section of the exit stay crown 15

The exit stay apparatus with intermediate exit flange introduces higher head losses in the flow leaving the turbine runner 7 then the prior art exit stay apparatus without intermediate exit flange by value (δζ)_{cr}. It happens, because of the bigger losses caused by the intermediate exit flange 9 and the increased solidity of the crown exit vanes 17, [(L/T)ₑᵥ]_{cr}, in comparison with solidity of exit vanes 6f the prior art exit stay apparatus in vicinity of the crown. Let us evaluate this increase in head losses.

The relative head losses caused by the exit stay apparatus without intermediate exit flange are:

$$Δζ = \frac{{( Δζ )}_{XI} {( Δ Q )}_{XI} + ( {Δζ}_{per} ) [ {Q}_{t} - {( Δ Q )}_{XI} ]}{{Q}_{t}} \qquad ( 8 )$$

where:
(Δζ)_{XI} is the relative head losses for the part of exit stay apparatus between exit stay crown and stream surface XI-XI,
(Δζ)ₚₑᵣ is the relative head losses for the part of exit stay apparatus between stream surface XI-XI and periphery,
Δ(Q)_{XI} is the flow between exit stay crown and stream surface XI-XI, and
Qₜ is the flow of the turbine.

On the other hand the relative head losses caused by the exit stay apparatus with intermediate exit flange are:

$${( Δ ζ )}_{if} = \frac{[ {( Δ ζ )}_{XI} + {( δζ )}_{cr} ] {( Δ Q )}_{cr} + {( Δζ )}_{per} [ {Q}_{t} - {( Δ Q )}_{cr} ]}{{Q}_{t}} \qquad ( 9 )$$

where:
ΔQ_{cr} is the flow between the exit stay crown 15 and the intermediate exit flange 16.

Now using the fact that (ΔQ)_{cr}≈(ΔQ)_{XI} one finally obtains the following relation between relative head losses in exit stay apparatuses with intermediate exit flange and without it:

$${( Δζ )}_{if} = Δζ + {( δζ )}_{cr} \frac{{( Δ Q )}_{XI}}{{Q}_{t}} \qquad ( 10 )$$

It is easy to see from formula (10) that for design value (ΔQ)_{XI}=0.05 Qₜ and highest expected at optimum (δζ)_{cr}=0.01:

(Δζ)_{if}=Δζ+0.0005 (11)

Therefore the presence of the intermediate exit flange 16 decreases the peak efficiency only on 0.05%. It is well known that the error of efficiency measurement during experiment is around 0.2%, therefore, the decreases in the peak efficiency on 0.05% is insignificant.

The profiles of the crown and peripheral exit stay vanes 17 and 18 are subsets of the axisymmetric stream surfaces of the flow leaving the turbine runner. The profile contours are the lines of intersection of said axisymmetric stream surfaces with exit vanes bounding surfaces.

The values of the design angles of inlet elements to the exit vanes 17 and 18, (βᵢ)_{des}, are defined by formula (7) in BRIEF SUMMARY OF THE INVENTION. The values of the design angles of exit elements fro the exit vanes 17 and 18, (βₑ)_{des}=90°. It is easy to see from (7) that at the crown profile (βᵢ)_{des}=90°, since at the crown (Vᵤ)ₒₚₜ=0.

Similarly values of the velocity vector angle at the profiles inlets at off peak operating regimes are defined by:

$${( tan {β}_{i} )}_{off} = \frac{{[ {( {V}_{m} R )}_{i} ]}_{off}}{{[ {( {V}_{u} R )}_{i} ]}_{off}} \qquad ( 12 )$$

where [(VₘR)ᵢ]_{off} and [(VᵤR)ᵢ]_{off} are the moments of meridional and circumferential components of velocity along the leading edge at off peak operating regimes of the turbine. So the angle of attack of velocity vector at profile inlet, γ=(βᵢ)_{des}−(βᵢ)_{off}. The test at Laval University (see BACKGROUND OF THE INVENTION) have shown that for the crown profile −65°≦γ≦46°. such a high variation of γ causes the separation of the flow at the profile inlet for values of |γ|>20°.

The separation of the flow at the inlet to the crown profiles produces an adverse effect on the capability of these profiles to eliminate the central vortex even for high solidity of their cascade.

As it can be seen from FIG. 1 the value of [(VₘR)ᵢ]_{off} can be substantially increased by presence of the intermediate exit flange 16 for the same value of [(VᵤR)ᵢ]_{off} and, therefore, variation of |γ| can be limited to the acceptable values and eliminate the flow separation at turbine operating regimes off peak.

Finally one can see that the geometry of the proposed exit stay apparatus 9 enables it to increase the turbine efficiency and substantially decrease the amplitude of pressure pulsations in draft tube cone at operational regimes other than optimum and retain the same peak efficiency.

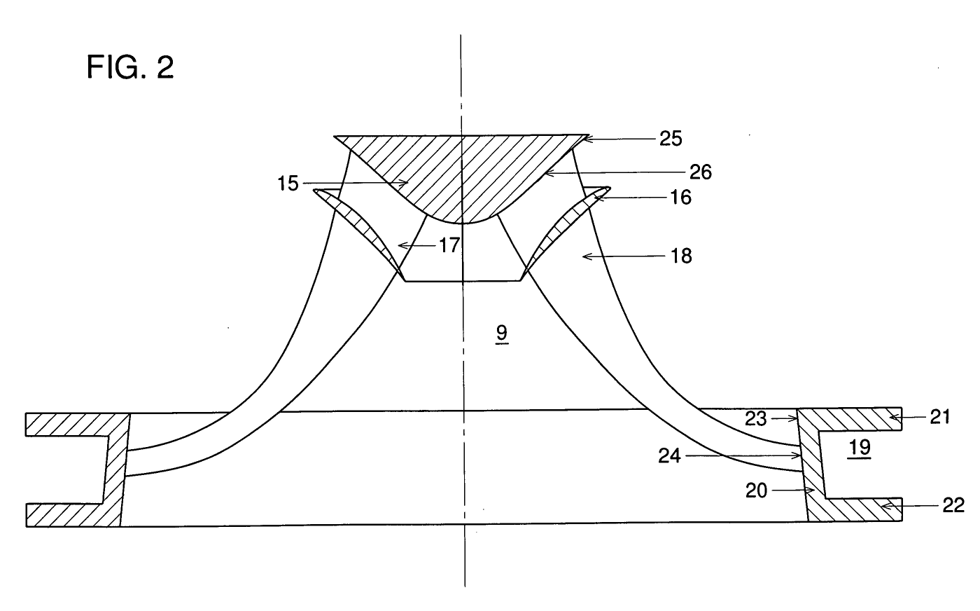

FIG. 2 shows an exit stay apparatus 9 with an exit stay crown 15, an intermediate exit flange 16, crown exit stay vanes 17, peripheral exit stay vanes 18, and exit stay flange 19. The crown exit stay vanes 17 are secured to the outer part 25 of the exit stay crown 15 and to the crown side of the intermediate exit flange 16. The peripheral exit stay vanes 18 are secured to the peripheral side of the intermediate exit flange 16 and to the outer part 23 of the side wall 20 of the exit stay flange 19.

The exit stay crown 15 has the shape of a cup and forms the water passages after the runner crown 7 of FIG. 1 when the exit stay apparatus 9 is installed in the turbine. Exit stay flange 19 comprises the side wall 20, the upper ring 21, and the lower ring 20. As was said above the inner part 21 of the side wall 20 is secured to peripheral profiles 24 of the peripheral exit stay vanes 16 and forms the water passage at the periphery when the exit stay apparatus 9 is installed in the turbine. Upper ring 21 is secured to the discharge ring 4 of FIG. 1 and lower ring 22 is secured to the draft tube cone 11 of FIG. 1 when the exit stay apparatus 9 is installed in the turbine.

To those skilled in the art it is clear that the exit stay apparatus with intermediate exit flange shown in FIGS. 1 and 2 differs from prior art exit stay apparatus (U.S. Pat. No. 6,918,744, Nov. 2005, for Hydraulic Turbine and Exit Stay Apparatus therefor).

I claim:

1. An exit stay apparatus for installation into a reaction hydraulic turbine, which has runner apparatus with runner blades secured to the runner crown, truncated at the bottom, and the draft tube cone, comprising an exit stay crown, an intermediate exit flange formed by two surfaces of revolution, a plurality of crown exit stay vanes secured to said exit stay crown and to crown side of said intermediate exit flange, a plurality of peripheral exit stay vanes secured to peripheral side of said intermediate exit flange;
and when installed into said reaction hydraulic turbine;
said exit stay crown is located immediately under said runner crown, which said exit stay crown together with said runner crown forms water passages at said runner apparatus exit;
said crown exit stay vanes cross water passages from said exit stay crown to said crown side of said intermediate exit flange and said peripheral exit stay vanes cross water passages from said peripheral side of said intermediate exit flange to the periphery, so that the entire flow of the water through said reaction hydraulic turbine must pass through the channels formed by said crown exit stay vanes, said intermediate exit flange, and said peripheral exit stay vanes;
said peripheral exit stay vanes are secured at the periphery and, therefore, said intermediate exit flange, said crown exit stay vanes, and said exit stay crown are supported by said peripheral exit stay vanes below said runner crown;
said exit stay crown does not touch other parts of said reaction hydraulic turbine besides said crown exit stay vanes.

2. An exit stay apparatus of claim 1 wherein the meridional cross-section of said intermediate exit flange has a shape of non-symmetric profile with rounded inlet and sharp exit.

3. An exit stay apparatus of claim 2 wherein said peripheral side of said intermediate exit flange is formed, excluding the inlet part, by a stream surface of the flow leaving the runner at optimum operating regime in the turbine when said exit stay apparatus is not installed

4. An exit stay apparatus of claim 1 for installation into said reaction hydraulic turbine with runner apparatus having an intermediate flange with truncated exit, which said intermediate exit flange does not touch said intermediate flange of said runner apparatus and said crown and peripheral sides of said intermediate exit flange are continuations of crown and peripheral sides of said intermediate flange of said runner apparatus.

5. An exit stay apparatus of claim 1 wherein said crown exit stay vanes are identical in shape, are evenly distributed around said exit stay crown, and the solidity of the cascades formed by profiles of said exit stay vanes (L/T)_{cr}, where L is the length of said exit vane profile and T is the maximum distance between adjacent profiles along circumference, has its value larger than 2.0.

6. An exit stay apparatus of claim 1 wherein said peripheral exit stay vanes are identical in shape, are evenly distributed around said exit intermediate exit flange, and the solidity of the cascades formed by profiles of said peripheral exit stay vanes (L/T)ₚₑᵣ, changes its value from high value between 0.9 and 1.0 at said intermediate exit flange peripheral side to small value, between 0.1 and 0.2, at the apparatus periphery.

7. An exit stay apparatus of claim 1 wherein said exit stay apparatus has an exit stay flange at the apparatus periphery secured to said draft tube cone with said peripheral exit stay vanes secured to said exit stay flange.
